(19) United States
(12) Patent Application Publication
(10) Pub. No.: US 2012/0119457 A1
(43) Pub. Date: May 17, 2012

(54) INFANT CAR SEAT WITH DETACHABLE BASE AND TRAVEL HANDLE

(76) Inventor: Lisa Williams, Charlotte, NC (US)

(21) Appl. No.: 13/387,091

(22) PCT Filed: Jul. 28, 2010
(86) PCT No.: PCT/US10/43602

§ 371 Date: Jan. 25, 2012

Related U.S. Application Data
(60) Provisional application No. 61/229,125, filed on Jul. 28, 2009.

(51) Int. Cl. B60N 2/28; B62B 7/00; B60N 2/26

(52) U.S. Cl. 280/30

(57) ABSTRACT

A car seating unit adapted comprising integrated extendable wheels such that the unit can be removed from a vehicle and reconfigured to a wheeled configuration and utilized as a stroller.

### CLAIM OF PRIORITY

The present non-provisional patent application claims the benefit of priority of prior-filed United States Provisional Patent Application No. 61/229,125, filed Jul. 28, 2009, the complete contents of which is hereby incorporated herein by reference.

### BACKGROUND

1. Field of the Invention

The present device relates generally to the field of infant car seats and more specifically to the multi-use infant car seats.

2. Background

Car seats are an essential piece of equipment for children. Several types of seats exist on the market, differing in price, size, and design. Although some seats are appropriate for use with children ranging from newborn infant to toddler size, many parents choose to first use an infant car seat and then purchase a larger seat when the child outgrows the first one.

Purchasing two car seats for a child can be a more expensive option than using one for the entire period a child requires such a seat. However, many infant seats, often referred to as “buckets,” are more convenient to use because the seat itself is easily removable from the car, while a base unit remains strapped inside the car. The “bucket” part securely snaps into the base with a hook or other similar coupling mechanism. In contrast, larger car seats must be strapped into the car and the child is placed into the seat and removed as needed.

Since infants tend to sleep frequently, especially in the car, it is desirable to be able to keep the child securely strapped in the seat and take the seat along while going about on errands, rather than waking the child to remove her from the seat. In fact, many restaurant highchairs and shopping carts are designed to accommodate an infant car seat bucket. Although it is convenient to carry the baby in the “bucket,” this can become a burdensome load, especially as the child nears the typical 20-25-pound weight limit of such seats.

Various types of carts and strollers exist that can accommodate an infant car seat to facilitate transporting the infant seat around. However, these carts, strollers and the like are separate pieces of equipment that must be stored in the car, taking up valuable space, when not in use. Further, it is an additional expense for new parents.

What is needed is an infant car seat that can be conveniently rolled around, yet still easily clipped into a detachable base unit in a car or shopping cart or high chair.

### BRIEF DESCRIPTION OF THE DRAWINGS

FIG. 1 depicts a side view of an embodiment of the present device.

FIG. 2 depicts a perspective exploded view of one embodiment of the present device.

FIG. 2a depicts a side detail view of an embodiment of a gear mechanism in the present device.

FIG. 2b depicts a top detail view of an embodiment of a gear and latch mechanism of the present device.

FIG. 3 depicts a side view of an embodiment of the present device.

FIG. 4 depicts a perspective view of the present device in a deployed position.

FIG. 5 depicts perspective view of an alternative embodiment of the present device.

### DETAILED DESCRIPTION

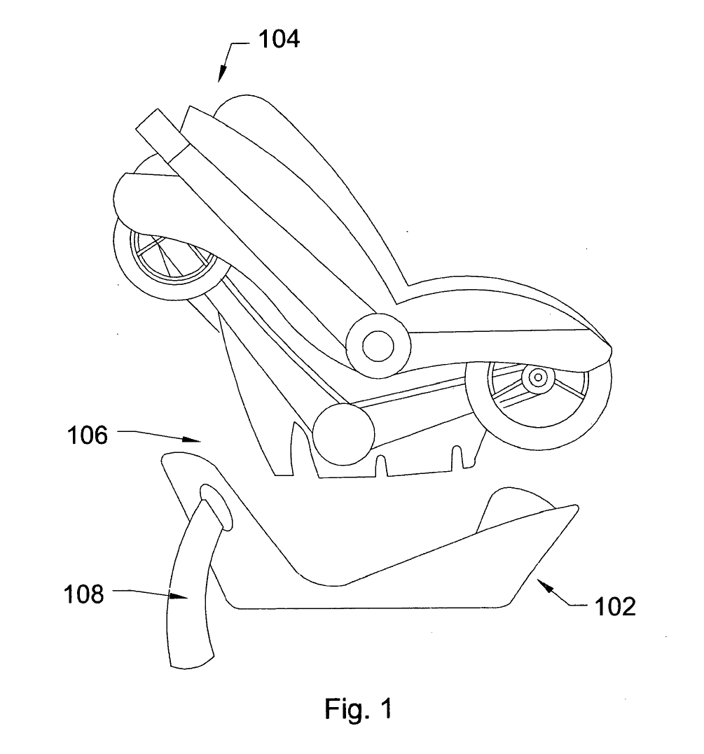

FIG. 1 depicts an expanded side view of an embodiment of the present device. An infant car seat can be comprised of a base unit 102 and a seating unit 104. A base unit 102 can have a concave interior 106 configured to selectively engage with the underside of a seating unit 104. At least one strap 108 can secure a base unit 102 to an automobile seat via a clip, latch, buckle, or any other known and/or convenient coupling mechanism.

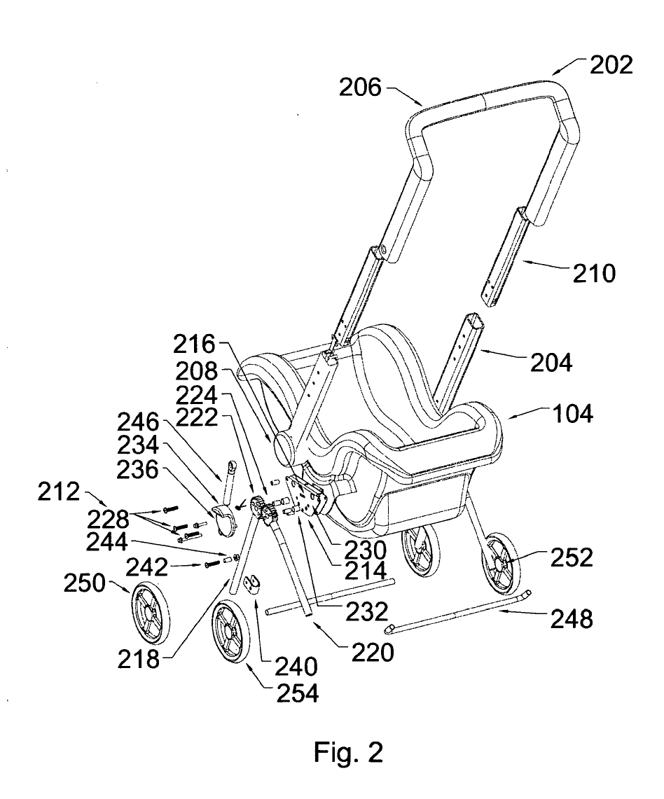

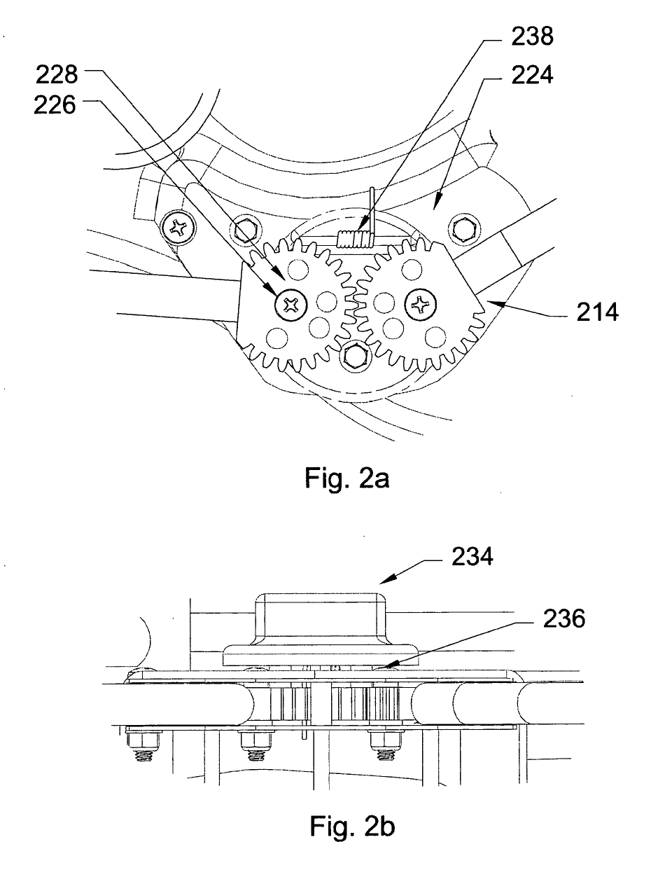

FIG. 2 depicts an expanded perspective view of one embodiment of the present device. In some embodiments, a handle 202 can be positioned astride the lateral sides of a seating unit 104. A handle 202 can further comprise at least one adjustable elongated member 204. In some embodiments, the adjustable elongated member 204 can have a quadrilateral geometry, but in other embodiments can have any other known and/or convenient geometry. As shown in the embodiment depicted in FIG. 2, a handle 202 can be comprised of an telescoping portion 210 that is rectilinearly and/or slidably coupled with the adjustable elongated member 204. The adjustable elongated member 204 and telescoping portion 210 can be coupled and configured such that a cross bar 206 can have a plurality of stop positions relative to the distal end of the adjustable elongated member 204 via a clip, pin, friction fit, actuated pin-aperture mechanism, or any other known and/or convenient mechanism. In some embodiments, the crossbar 206 can be adapted and/or configured to be slidable relative to the telescoping portion 210. However, in alternate embodiments, the crossbar 206 can be fixed relative to the telescoping portion 210. In some embodiments, the crossbar 206 can have a substantially circular cross-section. However, in alternate embodiments the crossbar 206 can have an ellipsoidal, quadrilateral, or any other known and/or convenient geometry.

The distal ends of adjustable elongated members 204 can each be connected to the lateral sides of a seating unit 104 by a pivoting mechanism 208 so that a handle 202 can be adjusted to a range of positions above a seating unit 104. In some embodiments, a pivoting mechanism 208 can be locked into one or more desired positions via a clip, pin, friction fit, ratchet, or any other known and/or convenient mechanism.

In some embodiments, a handle 202 can be extended away from a seating unit 104. As shown in FIG. 2, a handle 202 can have at least one telescoping portion 210 at least partially housed within or exterior to the body of an adjustable elongated member 204. In some embodiments, an adjustable elongated member 204 can include any known and/or convenient extension mechanism which allows collinear members to translate relative to one another. In some embodiments, the telescoping portion 210 can extend to at least one desired length and releasably lock into place at said length via a clip, pin, friction fit, actuated pin-aperture mechanism and/or any other known and/or convenient mechanism.

In some embodiments, adjustable elongated members 204, telescoping portions 210, a crossbar 206, and a pivoting mechanism 208 can be comprised of metal, alloy, plastic, composite, or any other known and/or convenient material. In some embodiments, the respective parts of a handle 202 can be comprised of the same material or of different materials in any other known and/or convenient combination.

As shown in FIG. 2, a wheel assembly 212 can be connected to each lateral side of a seating unit 104. In some embodiments, a wheel assembly 212 can comprise a base plate 214. As shown in FIG. 2, a base plate 214 can have a substantially trapezoidal geometry, but in other embodiments can have any other known and/or convenient geometry. In some embodiments a base plate 214 can have a plurality of holes 216, which, in some embodiments can be substantially circular to accommodate fasteners. In some embodiments, holes 216 can be threaded. However, in other embodiments, holes 216 can have any other known and/or convenient geometry.

In some embodiments, a wheel assembly 212 can further comprise a first elongated member 218 and a second elongated member 220. A first spur gear 222 can be integrated with or connected to the proximal end of a first elongated member 218 such that the longitudinal axis of a first spur gear 222 is oriented substantially perpendicular to the longitudinal axis of a first elongated member 218. A second spur gear 224 can be integrated with or connected to the proximal end of a second elongated member 220 such that the longitudinal axis of a second spur gear 224 is oriented substantially perpendicular to the longitudinal axis of a second elongated member 220. As shown in FIG. 2a, first spur gear 222 and second spur gear 224 can each have a substantially circular opening 226 along their respective longitudinal axes about which they can pivot.

In some embodiments, as shown in FIG. 2a, a first elongated member 218 and a second elongated member 220 can be aligned such that a first spur gear 222 and a second spur gear 224 can be meshed and substantially coplanar. In some embodiments the gear ratio of a first spur gear 222 and a second spur gear 224 can be 1:1, but in other embodiments, can be any other known and/or convenient ratio.

In some embodiments, as shown in FIG. 2a, fasteners 228 can be aligned and selectively engaged with each circular opening 226 in a first spur gear 222 and a second spur gear 224 and holes 216 in a base plate 214 to connect said gears to a base plate 214. In some embodiments, each fastener 228 can be a screw, but in other embodiments, a first spur gear 222 and a second spur gear 224 can be connected to a base plate 214 with a bolt, pin, or any known and/or convenient fastener. As shown in FIG. 2, spacers 230 and bushings 232 can be used in conjunction with a fastener 228.

As shown in FIGS. 2-2b, an actuation device 234 can have a front side facing outward from the lateral surface of a seating unit 104 and a back side substantially adjacent to the external faces of a first spur gear 222 and a second spur gear 224. Protrusions 236 can extend substantially perpendicularly from the back surface of an actuation device 234 and can selectively engage with holes in a first spur gear 222 and a second spur gear 224. A bias member 238 can be connected to an actuation device 234. In some embodiments, bias member 238 can be a torsional spring adapted and configured to selectively engage the protrusions 236 in the actuation device 234 and the holes in the first spur gear 222 and/or the second spur gear 224, in at least two alternate configurations. While depicted in FIGS. 2-2b as a torsional spring, in alternate embodiment any other known and/or convenient biasing device and/or mechanism can be employed.

In some embodiments, an eyelet 240 can be connected along the length of a first elongated member 218 and secured with an eyelet fastener 242, which can be a screw, bolt, pin, or any other known and/or convenient fastener. As show in FIG. 2, an eyelet spacer 244 can also be used in conjunction with an eyelet fastener 242 to secure an eyelet 240 to a first elongated member 218.

As shown in FIG. 2, a biasing member 246 can have its distal end connected to an eyelet 240 via an eyelet fastener 242 and its proximal end connected to a base plate 214 via a screw, bolt, or any other known and/or convenient fastener. In some embodiments, as shown in FIG. 2, a biasing member 246 can be a gas spring, but in other embodiments, and be an elastic member, a helical coil spring, or any other known and/or convenient device.

As shown in FIG. 2, cross braces 248 can be connected to the distal ends of substantially parallel pairs of elongated members 218 220.

In some embodiments, wheels 250 can be connected to the distal ends of the elongated members 218 220 via a pivoting wheel connector 252. In some embodiments, a pivoting wheel connector 252 can be a caster, but in other embodiments can be any other known and/or convenient device. In some embodiments, select wheels can be coupled with one or more elongated members 218 220 via pivoting wheel connectors 252 and/or connected in a fixed or substantially fixed configuration relative to the elongated members 218 220. Wheels 250 can be made of metal, polymer, or any other known and/or convenient material. In some embodiments, wheels 250 can further comprise tires 254. In still further alternate embodiments, one or more of the wheels 250 can be operatively coupled with foot-actuated brakes (not shown).

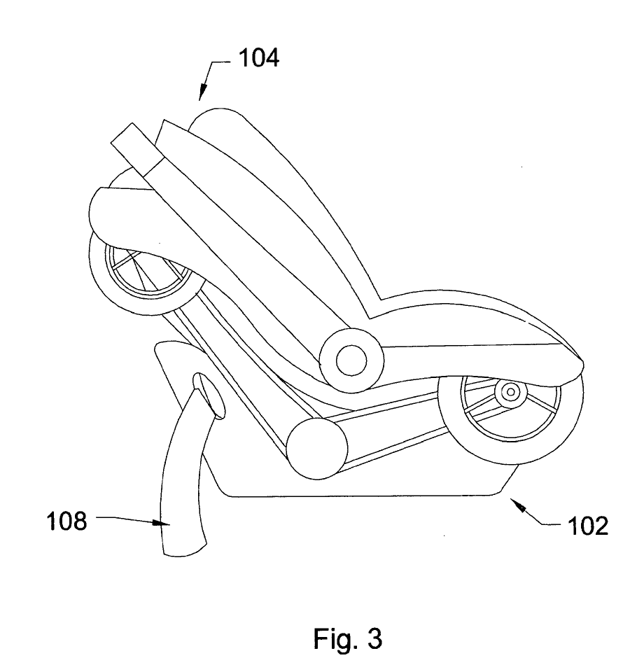

In operation, a seating unit 104 can be selectively engaged with and removably coupled to a base unit 102, which can be secured to an automobile seat via straps 108, as shown in FIG. 3. An infant can be placed in a seating unit 104 and secured in place with harness straps (not shown). Alternatively, an infant can be placed in a seating unit 104 first, and then a seating unit can be removably coupled to a base unit 102. In either case, a seating unit 104 can be secured to a base unit 102 with a locking mechanism such as a retractable clip and or via any other known and/or convenient selectively engageable mechanism (not shown).

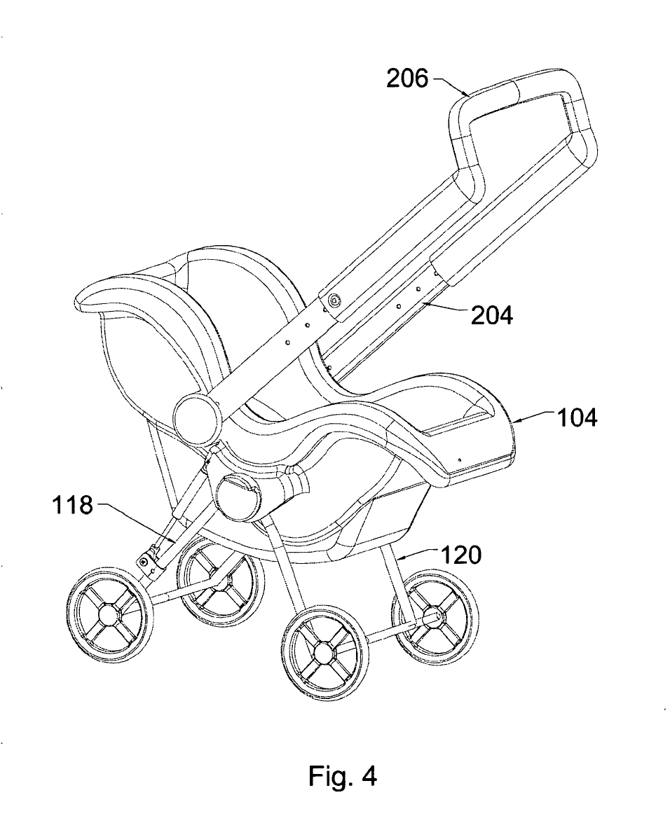

When a destination has been reached and it is time to exit a vehicle, a user can disengage a seating unit 104 from a base unit 102 and subsequently place a seating unit 104 on the ground, as shown in FIG. 4. A user can then pull a handle 202 with crossbar 206 away from a seating unit 104 to extend a handle 202 with crossbar 206 to a convenient length for pulling along a seating unit 104. In some embodiments, wheels 250 can substantially simultaneously extend away from a seating unit to provide enough clearance for wheels 250 to turn freely and raise a seating unit 104 off of the ground. In other embodiments, the user can independently release wheels 250 into position to freely rotate and raise a seating unit 104 off of the ground. A user can also adjust the angle of a handle 202 with crossbar 206. With handle 202 with crossbar 206 and wheels 250 extended, a user can now push or pull a seating unit 104 like a cart, stroller, as shown in FIG. 4. Alternately, the handle 202 can be rotated to a non-extended vertical or other position and the seating unit 104 can be lifted and carried with the wheel linkage contracted in the same or similar manner as a standard car seat can be carried.

When a user returns to a vehicle, a user can push a handle 202 in toward a seating unit 104 to retract a handle 202 with crossbar 206 back to its original position. Wheels 250 can then retract back into a recessed portion of a seating unit 104 either substantially simultaneously with retracting a handle 202 with crossbar 206 or as an independent operation. In operation, the actuation device 234 can be used to lock the legs in both the extended and contracted positions via holes in the two gears. One set of holes 216 can engage the device in the extended position, and another set of holes can engage the device in the contracted position. A user can then selectively engage with and removably couple a seating unit 104 to a base unit 102 as before.

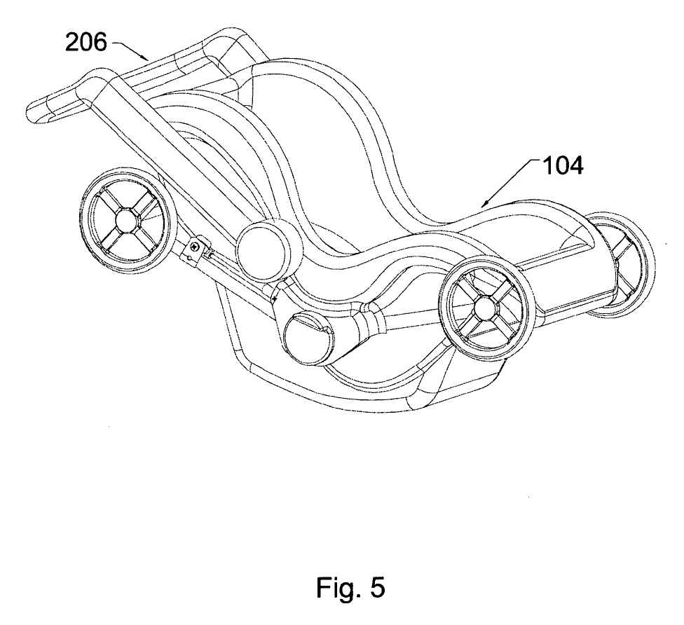

In some embodiments, wheels 250 can sit inside the lateral edges of a seating unit 104 when a seating unit is coupled with a base unit 102. However, in alternate embodiments, as shown in FIG. 5, wheels 250 can remain on the outside of the lateral edges of a seating unit 104.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. An infant car seat, comprising:
a base unit having straps to secure said base unit to an automobile seat;
a seating unit;
wherein said seating unit is removably coupled with said base unit;
an extendable handle laterally traversing said seating unit and having two ends, each end connected to the proximal end of one of a pair of substantially parallel adjustable elongated members, wherein the distal end of each substantially parallel adjustable elongated members is pivotally connected to a lateral side of said seating unit;
a pair of wheel assemblies each of which is connected to a lateral side of said seating unit, wherein each said wheel assembly further comprises
a first elongated member and a second elongated member, each having a proximal end and a distal end, and each terminating in a spur gear at the proximal ends of said elongated members, wherein said spur gears are operatively meshed; wherein said spur gears are connected with said seating unit such that the longitudinal axes of said spur gears are substantially perpendicular to vertical components of said seating unit;
a latch mechanism that selectively engages with said spur gears to lock and release said gears;
a biasing member connected with at least one elongated member and said seating unit;
a pivoting wheel connector connected with the distal end of each elongated member;
a wheel connected with said pivoting wheel connector.

2. The device of claim 1, further comprising a tire connected to said wheel.

3. The device of claim 1, wherein said wheels are adjacent to the lateral sides of a seating unit when in a retracted position.

4. The device of claim 1, wherein said seating unit further comprises a lip along its lateral edges, and wherein said wheels rest beneath said lip when in a retracted position.
